(19) United States
(12) Patent Application Publication
(10) Pub. No.: US 2021/0256953 A1
(43) Pub. Date: Aug. 19, 2021

(54) CONCURRENT FXLMS SYSTEM WITH COMMON REFERENCE AND ERROR SIGNALS

(71) Applicant: HARMAN INTERNATIONAL INDUSTRIES, INCORPORATED, Stamford, CT (US)

(72) Inventor: Jonathan Wesley CHRISTIAN, Mineral, VA (US)

(73) Assignee: HARMAN INTERNATIONAL INDUSTRIES, INCORPORATED, Stamford, CT (US)

(21) Appl. No.: 17/252,028

(22) PCT Filed: Jun. 14, 2019
(86) PCT No.: PCT/US2019/037228

§ 371 Date: Dec. 14, 2020

Related U.S. Application Data
(60) Provisional application No. 62/685,025, filed on Jun. 14, 2018.

(51) Int. Cl. G10K 11/178

(52) U.S. Cl. CPC G10K 11/17854; G10K 11/17823; H04R 2410/05; G10K 2210/3028; G10K 2210/1282

(57) ABSTRACT

A noise cancellation system for a vehicle audio system may include at least one input sensor arranged on an engine of a vehicle configured to provide an input signal indicative of acceleration or vibration detected at the engine and a processor. The processor may be programmed to receive a reference signal, apply at least one order tracking to reference signal, generate an error signal based on an output signal, and apply at least one other order tracking filter to the error signal to provide engine order cancelation of the input signal.

### CROSS-REFERENCE TO RELATED APPLICATIONS

This application claims the benefit of U.S. provisional application Ser. No. 62/685,025 filed Jun. 14, 2018, the disclosure of which is hereby incorporated in its entirety by reference herein.

### TECHNICAL FIELD

Disclosed herein are concurrent fxLMS systems with common reference and error signals.

### BACKGROUND

Vehicles often generate air-borne and structural-borne noise when driven. In an effort to cancel the noise, active noise cancellation is often used to negate such noise by emitting a sound wave having an amplitude similar to the amplitude as that of the noise, but with an inverted phase. The active noise cancellation systems within the vehicle may aim to reduce engine noise as well as road noise.

### SUMMARY

A noise cancellation system for a vehicle audio system may include at least one input sensor arranged on an engine of a vehicle configured to provide an input signal indicative of acceleration or vibration detected at the engine and a processor. The processor may be programmed to receive a reference signal, apply at least one order tracking to reference signal, generate an error signal based on the acceleration or vibration, and apply at least one other order tracking filter to the error signal to provide engine order cancelation of the input signal.

A noise cancellation method for engine order cancelation within a vehicle at system may include receiving a reference signal, applying at least one order tracking to reference signal, generating an error signal based on the acceleration or vibration, and applying at least one other order tracking filter to the error signal to provide engine order cancelation.

A noise cancellation system for a vehicle audio system may include at least one accelerometer arranged on an engine of a vehicle configured to provide a reference signal indicative of acceleration or vibration detected at the engine, at least one input sensor configured to transmit a narrowband input signal and a broadband input signal, and a processor. The processor may be programmed to receive the reference signal, receive the narrowband input signal and the broadband input signal, apply at least one order tracking to reference signal, apply a secondary path to the input signals to generate antinoise signals, sum the antinoise signals broadcast over the secondary path and the primary noise signals to generate an error signal, and apply at least one other order tracking filter to the error signal to provide engine order cancelation of the input signal.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which;

FIG. 1 illustrates an example active noise cancelation system in accordance with one embodiment;

FIG. 2 illustrates an example narrowband and broadband filter system of the system of FIG. 1; and

FIG. 3 illustrates an example process for the active noise cancelation system.

### DETAILED DESCRIPTION

As required, detailed embodiments of the present invention are disclosed herein; however, it is to he understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is an active noise cancelation (ANC) system using concurrent FxLMS algorithms with common reference and error signals. FxLMS may he used to cancel structural-borne noises where the reference signals are provided by the accelerometers placed on the chassis (e.g., road noise cancelation or RNC). Current engine order cancelation (EOC) and RNC systems have separate reference signals. Historically, the reference signal for EOC may be delivered via a controller area network (CAN) message or analog signal to represent the engine rotation per minute (RPM). For RNC, the reference signal may be acquired from accelerometers on the chassis. However, certain operating conditions are becoming increasingly complicated, making it difficult to deliver or trigger the reference signal for EOC via the CAN.

For example, a vehicle may operate in a towing mode. During towing, the added load on the engine may result in an increased vibration that an accelerometer may easily identify. The ANC system, however, has no way to identify what mode the vehicle is currently in. The system disclosed herein may place an accelerometer on the engine mount or another powertrain mount. This accelerometer may be used for both EOC and RNC with additional order tracking filters on the accelerometer signal. The change in vibration recognized by the accelerometer may indicate a change in vehicle mode, e.g., towing mode. The accelerometer signal may also provide varying amplitude information, contrary to the typical unity amplitude sign wave provided when using engine RPM.

By using a signal from the accelerometer placed on the engine mount, the signal may improve the convergence of the EOC system. Previously, EOC systems had to search for the correct magnitude and phase information while starting from unity amplitude in the magnitude portion of the filter. Because the disclosed system requires only one set of reference sensors and one set of error sensors for both the EOC system and RNC system, the build of materials and total costs are less. Thus, the system complexity is reduced. Broadband and narrowband signals may be extracted from the reference signal. Then, with a common output sensor and two sets of adaptive filters, the system may produce two sets of antinoise signals (MC and RNC).

The stability of the system is also improved. Aggressive tuning for high load conditions while maintaining stability under light load conditions, and vice versa, is a historical problem for classic EOC algorithms with rotational speed reference signals. This issue is resolved with accelerometers as reference signals for EOC. Furthermore, the latency of the reference signals received from the accelerometer is less than the CAN message. Thus, EOC performance improves.

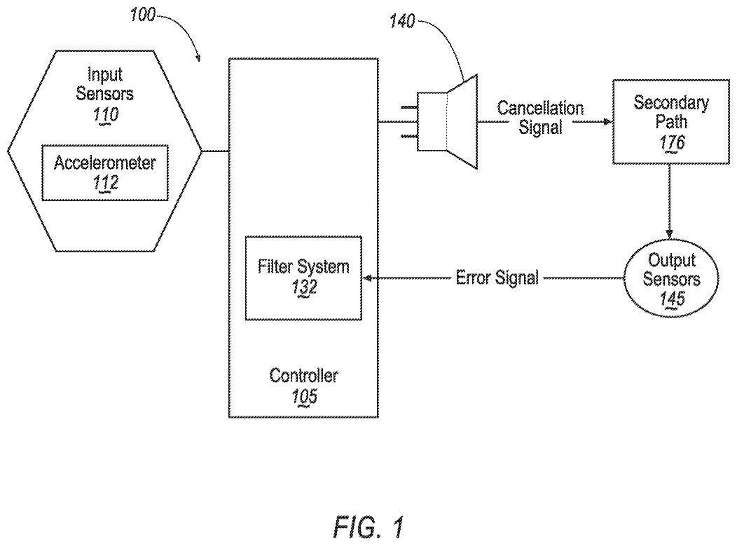

FIG. 1 illustrates an example active noise cancelation system 100 having a controller 105, at least one input sensor 110, and at least one transducer 140. The controller 105 may be a stand-alone device that includes a combination of both hardware and software components and may include a processor configured to analyze and process audio signals. Specifically, the controller 105 may be configured to perform broadband and narrowband noise cancellation for road noise cancelation (RNC), as well as active road noise cancellation (ARNC), within a vehicle based on received data from the input sensor 110. The controller 105 may include various systems and components for achieving ARNC such as a narrowband filter system 132.

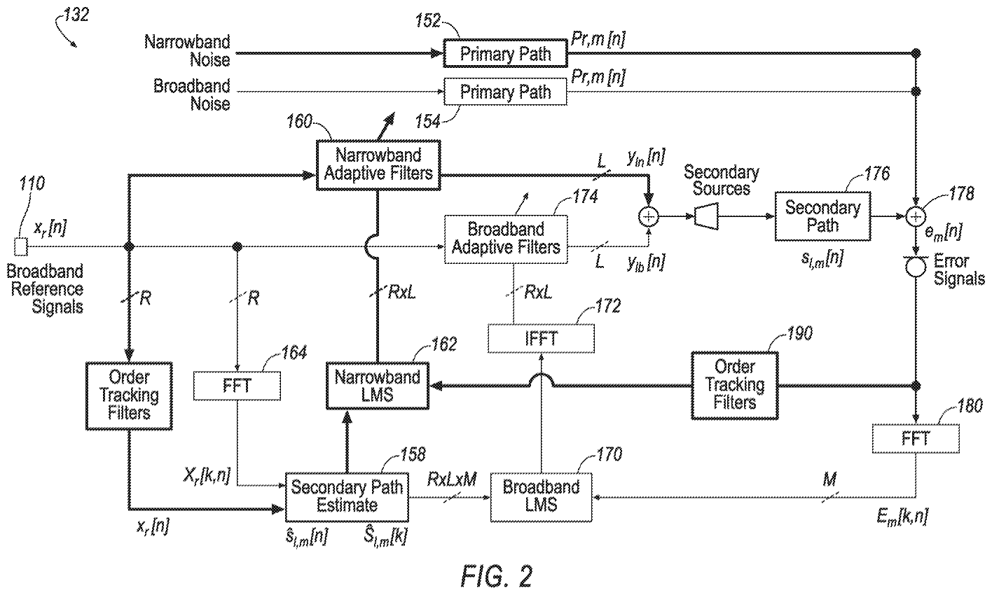

The input sensor 110 may be configured to provide an input signal to the controller 105. The input sensor 110 may include an accelerometer 112 configured to detect motion or acceleration and to provide an accelerometer signal to the controller 105. The acceleration signal may be indicative of a vehicle acceleration, engine acceleration, wheel acceleration, etc. The input sensor 110 may also include a microphone and/or a sound intensity sensor configured to detect noise. The input sensor 110 may detect both narrowband noise and broadband noise, as described in more detail with respect to FIG. 2. The input sensor 110 may also detect multiple sets of noise including a first narrowband noise signal set and a second narrowband noise signal set. Thus, a single sensor may detect both narrowband and broadband signals from a common reference signal.

The accelerometer 112 may be arranged on a powertrain mount, such as an engine mount of the vehicle. This accelerometer may be separate from the input sensors 110 and may be configured to detect acceleration or vibration at the engine. With the use of certain order tracking filters (as described with respect to FIG. 2), the accelerometer may produce an engine signal that identifies a change in vibration, thus leading the controller 105 to determine that the vehicle is in a different operating mode. The accelerometer 112 may be used as the reference signal for EOC, in lieu of a CAN message or analog tach signal. The accelerometer 112 may also replace traditional accelerometers arranged on the chassis used for RNC.

A mode could be determined by amplitude of the reference signal. In some situations, a detector may be included in the event that the amplitude exceed a detectable threshold of the accelerometer 112. For example, the frequency corresponding to the primary engine order (or some of it's harmonics) would likely be higher when in towing vs. not towing mode.

The transducer 140 may be configured to audibly generate an audio signal provided by the controller 105 at an output channel (not labeled). In one example, the transducer 140 may be included in a motor vehicle. The vehicle may include multiple transducers 140 arranged throughout the vehicle in various locations such as the front right, front left, rear right, and rear left. The audio output at each transducer 140 may be controlled by the controller 105 and may be subject to noise cancellation, as well as other parameters affecting the output thereof. The transducer 140 may provide the noise cancellation signal to aid in the ARNC to increase the sound quality within the vehicle.

The ARNC system 100 may include a feedback or output sensor 145, such as a microphone, arranged on a secondary path 176 and may receive audio signals from the transducer 140. The feedback sensor 145 may be a microphone configured to transmit a microphone output signal to the controller 105. The feedback sensor may also receive undesired noise from the vehicle such as road noise and engine noise. The output sensor 145 may provide the error signal at the primary path.

FIG. 2 illustrates a more detailed system 100 of FIG. 1 and includes an example filter system 132 of the ARNC system 100. The filter system 132 may include a narrowband primary path 152 supplying a time dependent primary narrowband propagation path P_{r,mn}[n] and a broadband primary path 154 supplying a time dependent primary broadband propagation path P_{r,mb}[n]. The primary paths 152, 154 may be audible signals acquired by the output sensors 145. The narrowband P_{r,ma}[n] and/or broadband noise broadband propagation path P_{r,mb}[n] may be acquired from a microphone, accelerometer, sound intensity sensor, etc.

The system 132 may receive a broadband reference signal xᵣ[n]. The broadband reference signal xᵣ[n] may be supplied by the accelerometer 112 to a broadband adaptive filter 174. The broadband adaptive filter 174 may filter the broadband reference signal xᵣ[n] and generate a broadband secondary signal y_{lb}[n].

A. first order tracking filters block 167 may be arranged between a narrowband adaptive filer 160 and the secondary path estimate block 158. The first order tracking filters block 167 may transform the broadband reference signal xᵣ[n] from a time domain to an angular or order domain. This tracking filter may allow the acceleration signal from the accelerometer 112 to be used for EOC. This adds minimal computational costs, while allowing the acceleration signal to be used for EOC.

The broadband reference signal xᵣ[n] may be provided to a Fast Fourier Transform block 164. An FFT may be applied to the broadband reference signal xᵣ[n] to provide a signal Xᵣ[k,n] in the frequency domain to the secondary path estimate block 158.

The secondary path estimate block 158 may estimate a secondary path for each the time domain and the frequency domain and determine an estimated secondary path in the frequency domain Ŝ_{l,m}[k] and an estimated secondary path in the time domain ŝ_{l,m}[n]. The secondary path estimate block 158 may provide a RxLxM matrix to a broadband least mean squared block 170, where:

R is the total dimensional number of reference signals,

L is the total dimensional number of secondary sources, and

M is the total dimensional number of error signals.

The broadband least mean square (LMS) block 170 may be an adaptive filter configured to apply filter coefficients of the least mean square of the error signals. An inverse FFT may then be applied to this signal at the IFFT bock 172. An RxL matrix may then be supplied to a broadband adaptive filter 174.

The secondary path estimate block 158 may also provide an RxLxM matrix to a narrowband least mean squared (LMS) block 162 which may be an adaptive tiller configured to apply filter coefficients of the least mean square of the error signals. The narrowband least mean squared block 162 may provide an RxL matrix to the narrowband adaptive filters 160.

The broadband adaptive filter 174 may supply the broadband secondary source signal Y_{lb}[n] and the narrowband adaptive filter 160 may provide narrowband secondary source signal Yₗₙ[n], each summed with the other. The summed secondary source signals Yₗₙ[n], Y_{lb}[n] may then pass through the secondary path s_{l,m}[n] 176. The secondary path s_{l,m}[n] 176 represents the transfer function of the acoustic system (speakers, microphones, and interior vehicle acoustics).

At summation 178, the anti-noise signal broadcast via the secondary path s_{l,m}[n] 176, and the undesirable noise propagating via the primary paths 152, and 154, sum resulting in an error signal eₘ[n]. The error signal eₘ[n] may be acquired from the output sensors 145 such as a microphone. The summed signal may be input into a Fast Fourier Transform 180 forming an estimated error signal eₘ[n].

An order tracking filter block 190 may then be applied to the error signal eₘ[n]. The second order tracking filter block 190 may transform the error signal eₘ[n] from a time domain to an angular or order domain. The order tracking filler block 190 may be applied similarly to the tracking filter block 167, or the second block 190 may be applied differently. Again, this tracking filter may allow the acceleration signal from the accelerometer 112 to be used for an error signal and EOC.

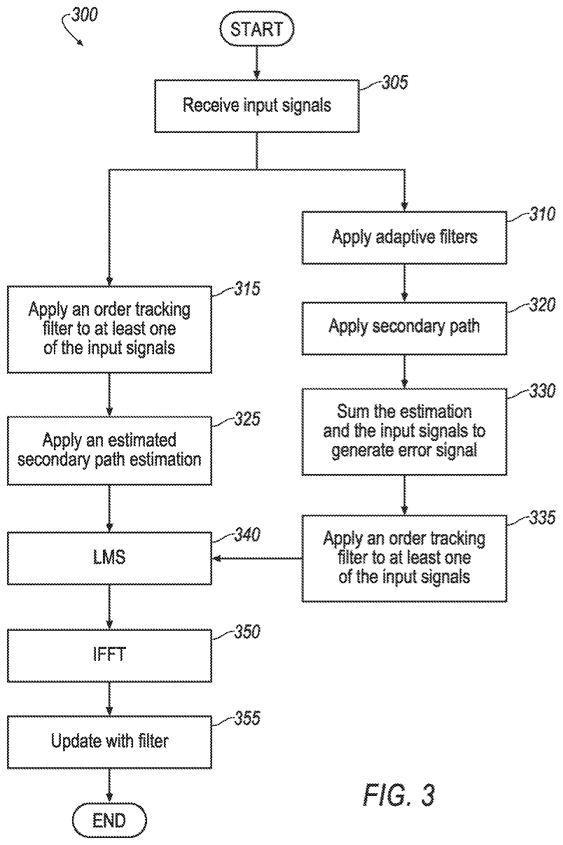

FIG. 3 illustrates an example process 300 for the active noise cancelation system. The process 300 may begin at block 305 where the controller 105 receives input signals.

At block 310, the controller 105 may apply adaptive fillers to the broadband reference signal xᵣ[n] in the forward path. The adaptive filters may include the narrowband adaptive filters 160 and or the broadband adaptive filters 174.

At block 315, the controller 105 may apply the order tracking filter 167 to one or more of the input signals.

At block 320, the controller 105 may apply a secondary path representing the electroacoustic transfer function of the system, similar to the secondary path estimate block 176 of FIG. 2.

At block 325, the controller 105 may apply a secondary path estimation (e.g., the second path estimate block 158) to the filtered input signal.

At block 330, the controller 105 may sum the antinoise and primary noise signals to generate an error signal. In this example, the antinoise signals broadcast over the secondary path s_{l,m}[n] 176 is summed with the noise coining from the primary paths 152, and 154, resulting in an estimated error signal eₘ[n].

At block 335, the controller 105 may apply the second order tracking filter 190 to the error signal eₘ[n]. The process 300 may proceed to block 345.

At block 340, the controller 105 may take the least means square (LMS) of the output from the secondary estimation from block 325.

At block 350, the controller 105 may take the IFFT of the signal at block 172.

At block 355, the controller 105 may update the system with the filter based on the process 300.

The process 300 may then end.

The embodiments of the present disclosure generally provide for a plurality of circuits, electrical devices, and at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any controller as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices ((e.g., FLASH, random. access memory (RAM), read only memory (ROM), electrically programmable read only memory (EPROM), electrically erasable programmable read only memory (EEPROM)) positioned within the housing. The controller(s) as disclosed also include hardware based inputs and outputs for receiving and transmitting data, respectively from and to other hardware based devices as discussed herein.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A noise cancellation system for a vehicle audio system, comprising:
at least one input sensor arranged on an engine of a vehicle configured to provide at least one input signal indicative of acceleration or vibration detected at the engine;
a processor programmed to:
receive a reference signal,
apply at least one order tracking filter to reference signal,
generate an error signal based on the acceleration or vibration, and
apply at least one other order tracking filter to the error signal to provide engine order cancelation of the input signal.

2. The system of claim 1, wherein the processor is further programmed to apply a secondary path to the input signals to generate an antinoise signal.

3. The system of claim 2, wherein the error signal is generated based on a summation of a primary path and the antinoise

4. The system of claim 1, wherein the processor is further programmed to apply a broadband adaptive filter to the reference signal.

5. The system of claim 1, wherein the at least one input sensor is an accelerometer arranged on the engine of the vehicle.

6. The system of claim 1, wherein the processor is further programmed to determine a vehicle mode based on the at least one input sensor.

7. The system of claim 6, wherein the vehicle mode is a towing mode.

8. A method for engine order cancelation for a vehicle audio system, comprising:
receiving, a reference signal,
applying at least one order tracking filler to the reference signal,
generating an error signal based on an acceleration or vibration of vehicle engine, and
applying at least one other order tracking filter to the error signal to provide engine order cancelation.

9. The method of claim 8, further comprising applying a secondary path to the reference signal to generate antinoise signals.

10. The method of claim 9, wherein the error signal is generated based on the antinoise signals.

11. The method of claim 8, further comprising applying a broadband adaptive filter to the reference signal.

12. The method of claim 8, further comprising determining a vehicle mode based on the reference signal.

13. The method of claim 12, wherein the vehicle mode is a towing mode.

14. A noise cancellation system for a vehicle audio system, comprising:
at least one accelerometer arranged on an engine of a vehicle configured to provide a reference signal indicative of acceleration or vibration detected at the engine;
an output sensor configured to provide primary noise signals;
a processor programmed to:
receive the reference signal,
extract a narrowband input signal and a broadband input signal from the reference signal;
apply at least one order tracking filter to the input signals,
apply a secondary path to the input signals to generate antinoise signals,
sum the antinoise signals over the secondary path and the primary noise signals to generate an error signal, and
apply at least one other order tracking filter to the error signal to provide engine order cancelation of the input signal.

15. The system of claim 14, wherein the processor is further programmed to apply a broadband adaptive filter to the reference signal.

16. The system of claim 14. wherein the processor is further programmed to determine a vehicle mode based on the reference signal.

17. The system of claim 16, wherein the vehicle mode is a towing mode.
